(19) United States
(12) Patent Application Publication
(10) Pub. No.: US 2012/0072290 A1
(43) Pub. Date: Mar. 22, 2012

(54) MACHINE GENERATED DYNAMIC PROMOTION SYSTEM

(75) Inventors: Ying Tat Leung, Saratoga, CA (US); Robyn R. Schwartz, Chicago, IL (US)

(73) Assignee: INTERNATIONAL BUSINESS MACHINES CORPORATION, Armonk, NY (US)

(21) Appl. No.: 12/886,074

(22) Filed: Sep. 20, 2010

(51) Int. Cl. G06Q 30/00

(52) U.S. Cl. 705/14.66; 705/14.72

(57) ABSTRACT

A system generates a product promotion dynamically personalized to a customer in a retail store. The customer is identified with a device coupled to a computer processor. A product interest device, also coupled to the processor detects the customer's interest in a product. Transaction history data and current promotion data is retrieved from online storage media. The system determines the profitability of the customer, the profitability of the product, and the business intention at that point in time. Along with the transaction history data and current promotion data the system creates a promotion for the customer and presents the promotion on a digital media display.

### BACKGROUND OF THE INVENTION

1. Field of the Invention

The invention relates to systems for generating and offering a product promotion to a customer. In particular the invention relates to systems which generate a promotion based on the profitability of the customer, the profitability of the product, and the business intention of the store. Even more particularly, the invention relates to systems in which the promotion is dynamically personalized to the customer based on the profitability of the customer, the profitability of the product, and the business intention along with transaction history data, inventory history of the product, and product promotion data.

2. Description of the Related Art

Many current retail programs focus on “cents off” promotions that do not necessarily drive profit for the retailer. These also require significant resource costs to create and implement.

Alternatively, customized promotions are used in the retail industry to capture the potential of customer-centric strategies over mass-market strategies. For example, Zhang, in his two papers entitled “Customizing Promotions in Online Stores,” Marketing Science, vol. 23, no. 4, Fall 2004, pp. 561-578; and “The Effectiveness of Customized Promotions in Online and Offline Stores,” j. Marketing Research, vol. XLV, 2008, 49 p. describes systems for customized promotions and the resulting benefits.

Ouimet, in U.S. Pat. No. 7,680,685 describes a computer system which models customer response including use of a transaction log to help retailers make effective promotion decisions.

Schroeder, in U.S. Pat. No. 7,689,456 also describes a system for planning and assessing the profitability of promotions. Schroeder uses a sales lift model with mathematical models for market response to promotion conditions.

Li, in U.S. Patent Application Publication 2008/0270231 describes tracking customer response to a coupon. Customer coupon usage patterns are captured and analyzed to provide insight into shopping habits. Coupons and promotions are then tailored to specific customers based on customer specific characteristics.

Baydar in his paper entitled “Agent-Based Modeling and Simulation of Store Performance for Personalized Pricing,” Proc. 2003 Winter Simulation Conf., pp. 1759-1764 describes agent-based modeling of store performance by optimizing a single objective which is a weighted combination of revenue, profit, and customer satisfaction. The results are used for personalized pricing of various retail products.

Alexiuk et al. in their paper entitled “Narrowcast Advertising Retail Metrics: A Simulation with Fuzzy Product Profitability Potential,” 2007 Canadian Conference on Electrical and Computer Engineering, Vancouver, Canada, pp. 784-787, Apr. 22-26, 2007, IEEE, Piscataway, N.J., 2007 10 Ref., describes defining product profitability potential of products in a retail outlet by fusing common retail metrics of sales data, surveys of customer product preferences, and advertising impressions. The products are interchangeable or functionally undistinguishable, but may have differing profit margins. Product profitability is assigned low, medium, or high. High level actions of do nothing, promote, or promote aggressively are proposed based on this assigned product profitability.

Chen et al. in their paper titled “Customer Centric Marketing with Internet Coupons,” Decision Support Systems, vol. 44, no. 3, Feb. 2008, pp. 606-620 describe customer-centric marketing with coupons distributed over the Internet. They show that randomly distributed coupons may hurt a firm's profitability. Changing face value coupons with customer profiling may be more profitable.

Levine in U.S. Patent Application 2002/0111852 describes personalizing on-line content presented to a customer by optimizing the value of the information presented. In particular the personalization is performed using in the moment, point of contact constraints of the customer; his profiled past; and retrieval of his current actions. The content may be an opportunity for the customer to make an immediate purchase.

Note that Robyn Levine of US 2002/0111852 is the same inventor as co-inventor Robyn Schwartz of the present invention.

The above papers by Zhang, Ouimet, Schroeder, Baydar, Alexiuk, and Cheng, as well as the U.S. Patent Applications by Li and Levine shall be incorporated herein by reference in their entireties for any purpose.

Despite all of the developments described above, there remains a need to improve the ways information is presented to potential customers in order to increase the profitability of retail businesses. In particular a system which focuses on the moment when a customer is looking at a product on a shelf, with an understanding of the buying cycle that the customer is engaged in has significant advantages over current methods. Such a system would constitute a significant advancement in the art of retail promotion systems.

### BRIEF SUMMARY OF THE INVENTION

A system and method generates a promotion for a product to a customer in a retail store. The system includes a customer identification device and a product interest detection device. Those of ordinary skill in hardware devices arts will recognize that a single physical hardware device may incorporate both the functions of a customer identification device and a product interest detection device, without departing from the description and spirit of the present invention. When a customer's interest in a product is detected, a computer searches transaction history data stored in online storage media, for that customer and product promotion data for that product. A promotion is dynamically personalized to the customer using the transaction history data, the product promotion data, inventory history of the product, profitability of the customer, profitability of the product and business intention. The promotion is presented to the customer on a digital media display.

### BRIEF DESCRIPTION OF THE SEVERAL VIEWS OF THE DRAWINGS

FIG. 1 depicts an exemplary computer in which the present disclosure may be implemented;

FIG. 2 is a block diagram of a system for generating a promotion; and

FIG. 3 is a flowchart depicting process steps in generating a promotion in accordance with the present invention.

### DETAILED DESCRIPTION OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

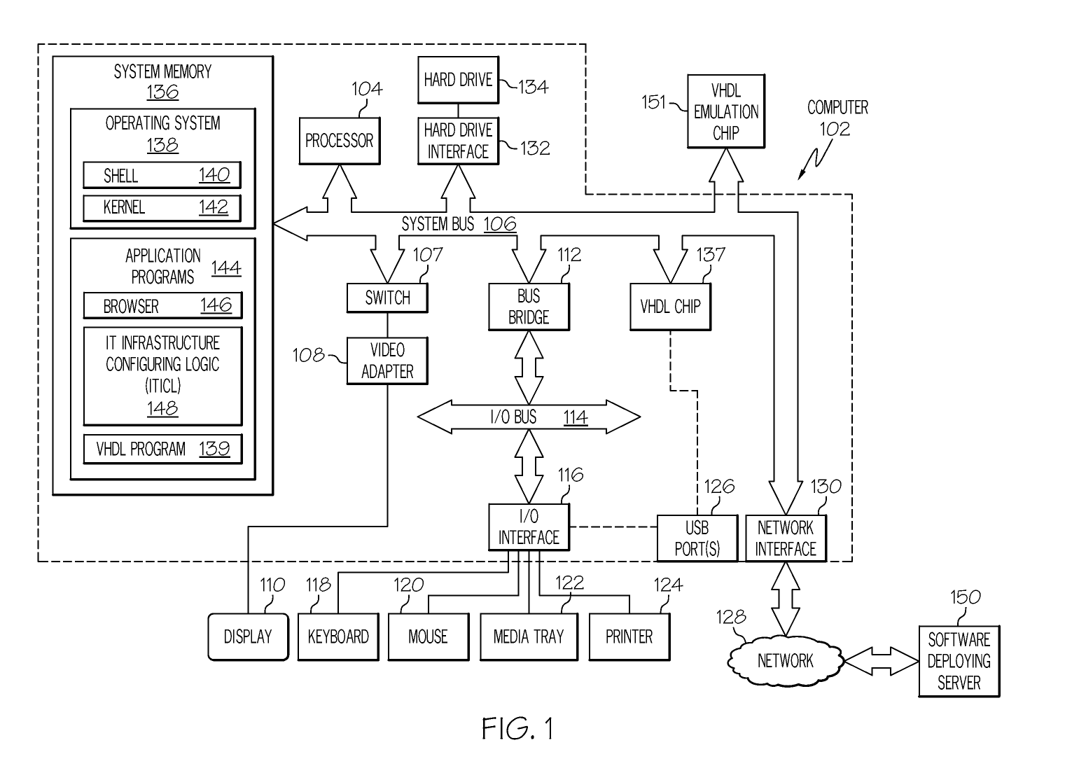

With reference now to the figures, and in particular to FIG. 1, there is depicted a block diagram of an exemplary computer 102, which may be utilized by the present invention. Note that some or all of the exemplary architecture, including both depicted hardware and software, shown for and within computer 102 may be utilized by software deploying server 150.

Computer 102 includes a processor 104 that is coupled to a system bus 106. Processor 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions (e.g., information technology infrastructure configuring logic-ITICL 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, computer 102 is able to communicate with a software deploying server 150 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

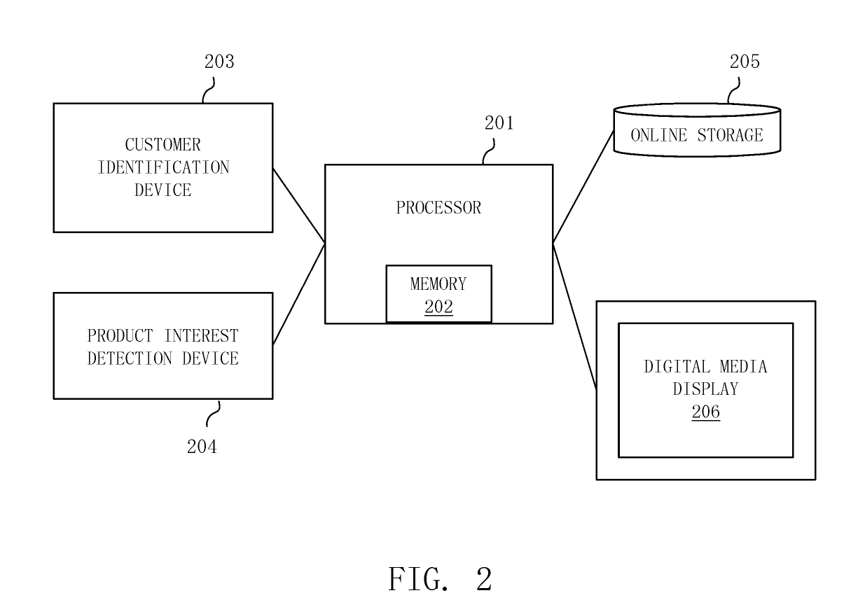

Application programs 144 in computer 102's system memory (as well as software deploying server 150's system memory) also include an information technology infrastructure configuring logic (ITICL) 148. ITICL 148 includes code for implementing the processes described below, including those described in FIGS. 2-7. In one embodiment, computer 102 is able to download ITICL 148 from software deploying server 150, including in an on-demand basis, wherein the code in ITICL 148 is not downloaded until needed for execution to define and/or implement the improved enterprise architecture described herein. Note further that, in one embodiment of the present invention, software deploying server 150 performs all of the functions associated with the present invention (including execution of ITICL 148), thus freeing computer 102 from having to use its own internal computing resources to execute ITICL 148.

Also stored in system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from ITICL 148 causes VHDL program 139 to configure VHDL chip 137, which may be an FPGA, ASIC, etc.

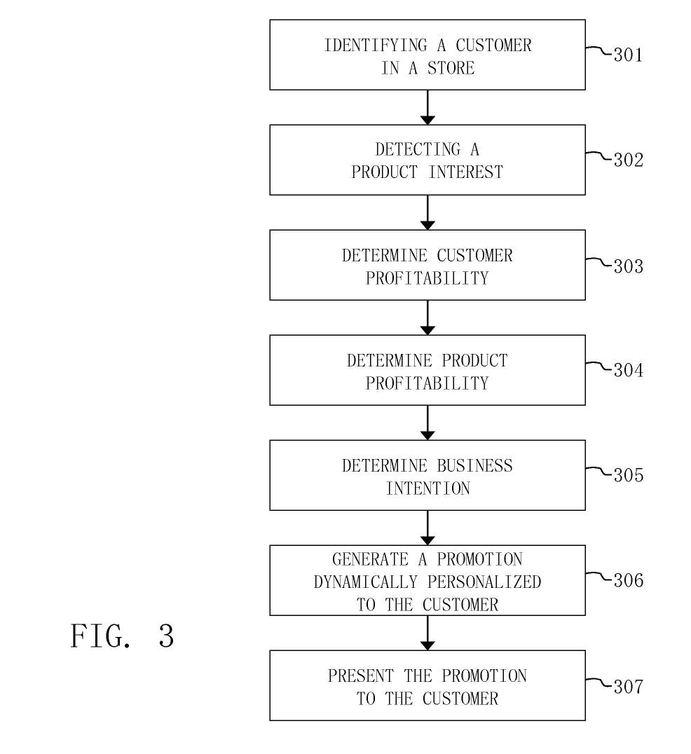

In another embodiment of the present invention, execution of instructions from ITICL 148 results in a utilization of VHDL program 139 to program a VHDL emulation chip 151. VHDL emulation chip 151 may incorporate a similar architecture as described above for VHDL chip 137. Once ITICL 148 and VHDL program 139 program VHDL emulation chip 151, VHDL emulation chip 151 performs, as hardware, some or all functions described by one or more executions of some or all of the instructions found in ITICL 148. That is, the VHDL emulation chip 151 is a hardware emulation of some or all of the software instructions found in ITICL 148. In one embodiment, VHDL emulation chip 151 is a programmable read only memory (PROM) that, once burned in accordance with instructions from ITICL 148 and VHDL program 139, is permanently transformed into a new circuitry that performs the functions needed to perform the process described below in FIGS. 2-3.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

In FIG. 2 there is shown a system for generating and offering a product promotion to a customer in a store (not shown). Processor 201 having memory 202 may be any type of computer device including the computer 102 shown in FIG. 1. The memory 202 may be system memory 136 or any other type of storage device such as hard drive 134 or a memory device attached through a network 128 via network interface 130. A customer identification device 203 is coupled to processor 201. Device 203 may be any device capable of identifying a customer in a store such as a video or still camera, fingerprint reader, badge reader, RFID device reader, keyboard, magnetic stripe card reader or the like. Device 203 may also achieve customer identification via recognition of a customer carried device as or before the customer enters the store or while the customer is within the store. Such carried devices may use bluetooth, RFID, NFC (near field communication) or other wireless and presence technologies for communication and unique identification. Device 203 may also include customer self identification or login into a store owned device such as a kiosk or other in-store or near-store apparatus.

Processor 201 also has a product interest detection device 204 attached thereto. Device 201 may be any type of product interest detection device whether operated automatically, such as a video camera, proximity sensor, microphone with speech recognition software or whether operated manually by the customer or a store clerk such as a button, keyboard, touch sensitive panel, barcode scanner, RFID reader, or similar input devices known in the art. The actual product code (SKU) of the product detected by product interest detection device 204 may be captured in-aisle via a cart-based or store owned device, an employee device, a customer owned device, or an installed stationary store device.

Online storage medium 205 is also attached to processor 201. Any type of storage medium device may be used including a hard drive 134 or a storage device attached to processor 201 across a network 128 via network interface 130. Online storage 205 contains transaction history data for various customers who have made store transactions in the past including items purchased, date/time, price paid, promotions offered and accepted.

Current product promotion data for products which are for sale in the store is also contained in online storage 205. The term promotion shall be taken herein to mean a special product offering differing from the normal course of business for the product such as a temporal offering—it is offered on a time-stamped basis and offered to a particular individual based on customer profitability, product profitability, and business intention. The business intention may be customer conversion, up-sell, increased basket ring, increased basket size, or new product switch. Promotion may also be taken to mean special pricing or pairing of one product with others to create a solution sell effect or to move the customer from one product to another based on current interest or selection.

Memory 202 has instructions stored therein for determining the profitability of a customer identified by device 203. The customer profitability is determined based on the customer's known transaction history; customer loyalty as indicated by frequency of visits, average basket ring, current shopping cart items, profile history including buying profile, current location, customer value profile, and rate of conversion; and the current potential transaction which will depend on the output of product interest detection device
A customer value profile is determined by answers to the following questions:

How does this customer buy (on promotion or full price)?

What is the average product or category price paid by this customer?

What is the frequency of purchases by this customer?

Are they a loyal customer?

How often do they abandon transactions?

How quickly do they convert?

What is their average basket size?

What is their average basket ring (in dollars)?

The answers to these questions are stored in Memory 202, for use in determining customer profitability.

Memory 202 also has instructions stored therein for determining the product profitability of the product identified by interest detection device 201. Product profitability is determined based on the margin for that product at the time the interest is detected, and whether that product has current promotion data contained in online storage 205, how long the product has been held in store inventory, what is the current holding cost, what is the duration to end of life of this product (expiree, seasonal, end of trend), and what is the average inventory turn rate for this product.

Memory 202 also has instructions stored therein for obtaining and storing the business intention of the store. The business intention is to create a product level conversion to achieve a business positive customer behavior, such as messaging, increased loyalty, up-sell, cross-sell, or a new product purchase.

Memory 202 further has instructions stored therein for generating a promotion for the product dynamically personalized to the customer identified by device 203 based on the transaction history data, the stored product promotion data, the inventory history of the product, the profitability of the customer, the profitability of the product, and the business intention. The promotion is the mechanism to create the conversion described above.

The personalized promotion which may include a special price for a limited time, or with an expiration time, is then presented to the customer on digital media display 206 which may be the customer's mobile phone, an in-store kiosk, a sales associate mobile device, a price checker device, electronic shelf label, a digital display, or any other digital media display known in the art at the time identification device 203 identified the customer.

In FIG. 3 there is shown a flowchart of steps performed by the system of FIG. 2. In step 301, a customer in a store is identified by device 203 which is coupled to processor 201 of the present invention system. In step 302, product interest detection device 204 detects the customer is interested in one or more products. The system determines the customer profitability, as described above, in step 303 and also determines the product profitability in step 304, and business intention is step 305.

A promotion is then generated in step 306. The promotion is dynamically personalized to the identified customer for the product for which interest was detected. The system generates the promotion based on the customer's transaction history which is retrieved from online storage 205, current promotion data also from storage 205, the customer profitability determined in step 303, the product profitability determined in step 304, and the business intention of the store.

In step 307, the promotion is presented to the customer on digital media display 206.

While there have been shown and described what are at present considered the preferred embodiments of the invention, it will be obvious to those skilled in the art that various changes and modification may be made therein without departing from the scope of the invention as defined by the appended claims.

What is claimed is:

1. A system for generating and offering a product promotion to a customer in a store, comprising:
a computer processor having a memory;
a customer identification device coupled to said processor;
a product interest detection device;
online storage medium coupled to said processor, containing transaction history data for a customer identified by said customer identification device, and product promotion data for a product identified by said product interest detection device;
a digital media display in communication with said processor;
instructions stored in said memory for determining the profitability of said customer, the profitability of said product, and the business intention;
instructions stored in said memory for generating a promotion for said product, said promotion dynamically personalized to said customer based on said transaction history data, said product promotion data, inventory history of said product, said profitability of said customer, said profitability of said product, and said business intention, and thereafter presenting said promotion to said customer on said digital media display.

2. The system of claim 1, wherein said promotion is presented to said customer with an associated expiration.

3. The system of claim 1, wherein said product interest detection device is coupled to said processor.

4. The system of claim 1, wherein said transaction history data comprises items purchased, date/time, price paid, and promotions offered and accepted.

5. The system of claim 1, wherein said profitability of said customer is determined by said transaction history, customer loyalty, and current potential transaction as indicated by said product interest detection device.

6. The system of claim 1, wherein said profitability of said product is determined by the margin for said product at the time interest is detected by said product interest detection device, whether that product has current promotion data in said online storage medium, how long said product has been held in store inventory, and the current holding cost.

7. A computer implemented method of offering a product promotion to a customer, comprising the steps of:
providing a computer processor having a memory, a customer identification device attached thereto, a product interest detection device attached thereto, attached online storage media, and a digital media display;
identifying a customer using said identifying device;
detecting the customer's interest in a product using the interest detection device;
retrieving transaction history data for said customer from said online storage;
retrieving current promotion data for said product detected by said interest detection device, from said online storage;
determining the profitability of said customer, the profitability of said product, and the business intention;
generating a promotion for said product, said promotion dynamically personalized to said customer based on said transaction history, said current promotion data, said profitability of said customer, said profitability of said product, and said business intention; and
presenting said promotion to said customer on said digitally media display.

8. The method of claim 7, wherein said promotion is presented to said customer with an associated expiration time.

9. The method of claim 7, wherein said transaction history data comprises items purchased, date/time, price paid, and promotions offered and accepted.

10. The method of claim 7, wherein said current promotion data comprises a temporal offering, offered on a time-stamped basis.

11. The method claim 7, wherein said profitability of said customer is determined by said transaction history, customer loyalty, and current potential transaction as indicated by said product interest detection device.

12. The method of claim 7, wherein said profitability of said products is determined by the margin for said product at the time interest is detected by said product interest detection device, whether that product has current promotion data in said online storage medium, how long said product has been held in store inventory, and the current holding cost.

13. A computer program product for offering a product promotion to a customer in a retail store, said computer program product, comprising:
a computer readable storage media;
first program instructions for receiving a customer identification from a customer identification device;
second program instructions for receiving a product interest for the customer as detected by a product interest detection device;
third program instructions for retrieving transaction history data for the customer, from online storage media, and product promotion data for the product, from the online storage media;
fourth program instructions for determining the profitability of the customer, the profitability of the product, and the business intention;
fifth program instructions for generating a promotion for the product, said promotion dynamically personalized to the customer based on the transaction history, the product promotion data, inventory history of the product, the profitability of the customer, the profitability of the product, and the business intention; and
sixth program instructions for thereafter presenting the promotion to the customer on a digital media display; and
wherein
the first through sixth program instructions are stored on the computer readable storage media.

14. The computer program product of claim 13, wherein said promotion is presented to the customer with an associated expiration time.

15. The computer program product of claim 13, wherein said profitability of said customer is determined by said transaction history, customer loyalty, and current potential transaction as indicated by said product interest detection device.

16. The computer program product of claim 13, wherein said profitability of said product is determined by the margin for said product at the time interest is detected by said product interest detection device, whether that product has current promotion data in said online storage medium, how long said product has been held in store inventory, and the current holding cost.
